(19) United States
(12) Patent Application Publication
(10) Pub. No.: US 2024/0281519 A1
(43) Pub. Date: Aug. 22, 2024

(54) DATA RIGHTS ENFORCEMENT IN SECURE ENCLAVES

(71) Applicant: R3 Ltd., London (GB)

(72) Inventor: Rui Pedro Silva Marques de Almeida, London (GB)

(21) Appl. No.: 18/110,880

(22) Filed: Feb. 16, 2023

(51) Int. Cl. G06F 21/53; G06F 21/62

(52) U.S. Cl. CPC G06F 21/53; G06F 21/6218; G06F 2221/034

(57) ABSTRACT

A host computing system executes a secure enclave to provide secure processing of sensitive data. When the secure enclave is processing sealed data stored in a secure data repository, the secure enclave generates a dynamic challenge to an owner of the sealed data. The owner determines whether the secure enclave is trusted, for example based on auditing of the secure enclave or based on evaluation of a privacy policy. If the enclave is trusted, the owner returns a challenge response to the challenge. Based on the challenge response, the secure enclave unseals the sealed data and performs a computation on the unsealed data.

### BACKGROUND

Some types of applications process sensitive data in trusted execution environments (TEEs) to, for example, ensure authenticity of an output of the application, protect privacy of the data input to the application, or reduce the ability of other applications to tamper with the execution of the application. Private data sent to an enclave for processing may be stored in memory or sealed to disk in a manner that seeks to ensure the enclave is the only entity that can access the data. However, despite all attempts to patch an enclave against known attacks, a malicious actor may discover a new vulnerability in an enclave or host system that enables the malicious actor to access sensitive data via a side channel attack. For example, a malicious host may execute an enclave or initiate a new enclave to unseal sensitive data from disk.

### BRIEF DESCRIPTION OF THE DRAWINGS

Detailed descriptions of implementations of the present invention will be described and explained through the use of the accompanying drawings.

FIG. 1 is a block diagram of a host computing system, according to some implementations.

FIG. 2 is a block diagram illustrating an environment in which third-party auditing of secure enclaves is performed, according to some implementations.

FIG. 3 is an interaction diagram illustrating a process for initializing secure enclaves for processing data from clients, according to some implementations.

FIG. 4A is an interaction diagram illustrating a process for processing client data in a secure enclave, according to some implementations.

FIG. 4B is an interaction diagram illustrating another process for processing client data in a secure enclave, according to some implementations

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Secure enclaves within a host computing system are often used to securely process sensitive or private data because such enclaves provide protection of the data against malicious actors. However, despite best efforts to ensure that a secure enclave is invulnerable to attacks, malicious actors may find workarounds or may exploit new vulnerabilities to gain access to sensitive data. To solve these problems, the inventors have conceived of and reduced to practice a system and process for data rights revocation within a secure enclave. According to some implementations, when a secure enclave is processing sealed data stored in a secure data repository, the secure enclave generates a dynamic challenge to an owner of the sealed data. The owner determines whether the secure enclave is trusted, for example based on auditing of the secure enclave or based on evaluation of a privacy policy. If the enclave is trusted, the owner returns a challenge response to the challenge. Based on the challenge response, the secure enclave unseals the sealed data and performs a computation on the unsealed data.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Trusted Execution Environment

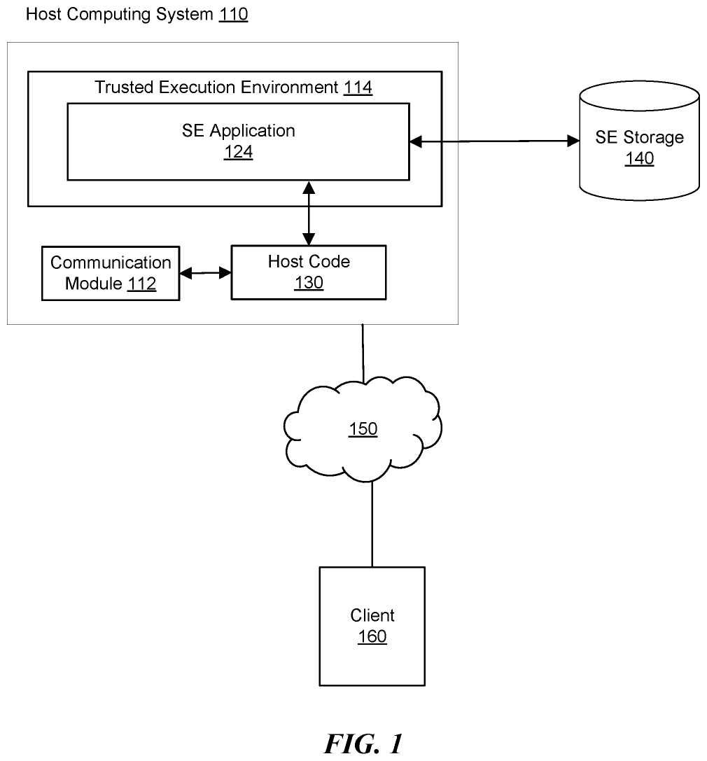

FIG. 1 is a block diagram of a host computing system 110, according to some implementations. As shown in in FIG. 1, the host computing system 110 includes a trusted execution environment (TEE) 114, a communication module 112, and host code 130.

The TEE 114, also referred to as a secure enclave, refers to a feature of a central processing unit (“CPU”) in which code and data of code (i.e., trusted code) are stored in memory in encrypted form and decrypted only when retrieved for use by the CPU. Such code is said to execute in the secure enclave. During manufacture, the secure enclave is provided a set of CPU private keys. The CPU private keys are stored in such a way that they cannot be altered in any way, including being deleted. The CPU supports generating an attestation of the trusted code that executes in the secure enclave. The attestation includes a hash of the trusted code, an identifier of the CPU, and application data. The attestation is signed by a CPU private key that is known to the manufacturer. A client can request the CPU to provide the attestation as evidence of the trusted code that executes in the secure enclave. The client can request a service of the manufacturer of the CPU to verify the signature. The client can then verify that the hash is a hash of the trusted code that the client expects. The attestation may also include a public key that the client can use to encrypt data that the secure enclave can decrypt using the corresponding private key. An example type of secure enclave that can be used by the host computing system 110 is that provided by the Software Guard Extensions (“SGX”) feature of Intel Corporation.

The TEE 114 creates a tamper-proof space for the code of a secure enclave (SE) application 124 to execute, so that other portions of the host computing system 110 (including the host code 130) cannot inspect or interfere with its execution. The TEE 114 protects data at rest (within the TEE), in motion (between the TEE and storage), and during computation (within the TEE). Before engaging with a TEE of another node, the TEE 114 can produce an attestation that it has been secured, is running the correct code of the application 124, and has not been tampered with. The code of the application 124 communicates with other nodes, such as the client 160, using encrypted messages, for example, encrypted transaction offers. The encryption may be based on public/private key pairs or symmetric keys of the application.

The TEE 114 can provide isolated tamper-proof enclaves for each of multiple SE applications 124 executed within the host computing system 110. For example, an enclave is managed for an SE application corresponding to each of a plurality of host applications executed by the host computing system 110, such that each of the plurality of host applications corresponds to a different, isolated enclave. The host computing system 110 maintains a record of all enclaves that have been created, for example in an enclave page cache (EPC). The EPC represents a subset of processor reserved memory (PRM), which cannot be directly accessed by other software within the host computing system 110 or by an external system. Each enclave can be allocated a pointer to its own memory area in a shared memory between the host application and the SE application 124 to reduce the ability of the host to pass information between enclaves using the shared memory.

An enclave further includes a certificate of the author of the enclave. The certificate is referred to as an Enclave Signature (SIGSTRUCT). The enclave signature includes an enclave measurement, the author's public key, a Security Version Number (ISVSVN) of the enclave, and a Product ID (ISVPRODID) of the enclave. The enclave signature is signed using the author's private key. The enclave measurement is a hash of the trusted code and its initial data. When the code is loaded into protected memory (EPC), the CPU calculates a measurement that is used as an enclave identifier and stores the measurement in an MRENCLAVE register. If the calculated measurement is not equal to the enclave measurement, the CPU will not allow the enclave to be initialized within the TEE. After the enclave is initialized, the CPU stores a hash of the author's public key in a MRSIGNER register as an identifier of the author. The ISVSVN specifies the security level of the enclave. The ISVPRODID identifies the product the enclave represents. The CPU records both the ISVSVN and ISVPRODID.

A client 160 that is to interact with an enclave may require the TEE to “attest” to the trusted code and data of the enclave. To provide an attestation to a client that may be executing on a platform that is different from the platform of the CPU that is executing the enclave (referred to as “remote” attestation), the TEE 114 generates a “report” that includes the enclave identifier (MRENCLAVE), hash of the author's public key (MRSIGNER), attributes of the enclave, and user data of the enclave. The report is passed to a quoting enclave (QE) to verify and sign the report. When verified, the QE generates a “quote” that includes the report and a signature of the TEE. The quote is then sent to the client 160.

Upon receiving a quote, the client 160 can verify the signature and, if verified, ensure that the report represents the trusted code that the client expects. The signature may be based on an Enhanced Privacy ID (EPID) in which different TEEs have different private keys, but signatures based on those private keys can be verified using the same public key. The client may invoke the services of an EPID verification service to verify a signature on a quote.

An enclave that is to interact with another enclave that is executing on the same platform may want the other enclave to attest to its trusted code and data. In such a case, a simplified version of attestation can be used (referred to as “local” attestation). To initiate an attestation, the requesting enclave send its MRENCLAVE measurement to an attesting enclave. The attesting enclave requests the CPU to generate a report destined to the requesting enclave identified by the MRENCLAVE measurement that it received and sends the report to the requesting enclave. The requesting enclave then asks the CPU to verify the report. The attesting enclave may request the requesting enclave to provide an attestation to affect a mutual attestation.

A TEE 114 provides support for an enclave to encrypt data that is to be stored outside of the TEE and to decrypt the encrypted data when it is later retrieved into the TEE. This encrypting and decrypting is referred to as “sealing” and “unsealing.” The TEE 114 generates an encryption key and a decryption key based on a “fused key” that is not known outside of the hardware. The fused key is fused into the CPU hardware during the manufacturing process of the CPU, is not known outside of the CPU not even by the manufacturer, is unique to the CPU, and cannot be accessed except by the hardware. Upon request, the CPU generates a sealing key and unsealing key (e.g., public/private keypair) that is based on the fused key and data associated with the requesting enclave. Thus, each sealing key and unsealing key is unique to the CPU because the fused keys are unique.

The CPU can generate two types of keys based on the associated data of the enclave that is used when generating the keys. The associated data is the MRENCLAVE (referred to as “sealing to the enclave”) or the combination of the MRSIGNER, ISVSVN, and ISVPRODID (referred to as “sealing to the author”). Data that is sealed to the enclave can only be unsealed by an enclave with the same MRENCLAVE value that is executing on the same CPU (i.e., using the same fused key) that generated the sealing key. Data that is sealed to the author can be unsealed by any enclave (e.g., different trusted code) of the author that has the same ISVPRODID and the same or an earlier ISVSVN (specified in a request to seal or unseal) and that is executing on the same CPU (i.e., using the same fused key) that generated the sealing key. (Note: The CPU will not generate seal-to-the-author keys for an ISVSVN that is greater than the ISVSVN of the enclave, which allows for only backward compatibility of sealing.) The TEE 114 provides a seal application programming interface (API) for sealing data and an unseal API for unsealing data.

The host code 130 represents untrusted code that executes outside of the TEE 114. The host code 130 is configured to interface or communicate with external systems, such as the clients 160, to pass data between the external systems and the TEE 114. For example, the host code 130 receives encrypted client data from the client systems 160 and encrypted application data (e.g., emails) from the SE storage 140 and provides the encrypted data to the SE application 124. The host code 130 can also receive encrypted application data from the SE application 124 and store the encrypted application data to the SE storage 140.

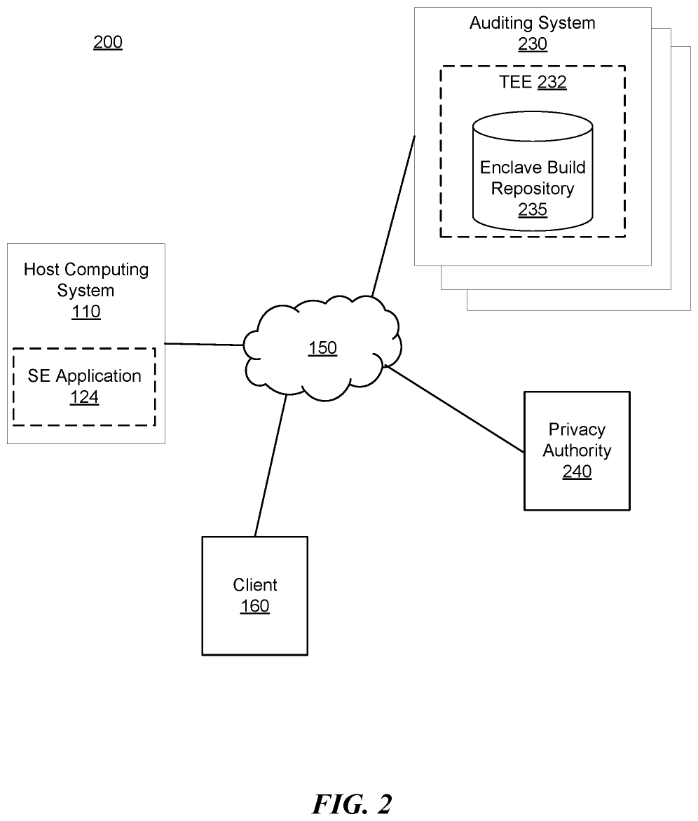

In addition to or instead of requiring a TEE to attest to the code executed in a secure enclave, the client 160 or a local application (such as the host code 130 or another SE application) may request a third-party audit of the enclave identifier. A third-party auditor is described with respect to FIG. 2.

FIG. 2 is a block diagram illustrating an environment 200 in which third-party auditing of secure enclaves is performed. As shown in FIG. 2, the environment 200 includes the host computing system 110, one or more client devices 160, one or more auditing systems 230, and a privacy authority 240. Communications between the host computing system 110, client device(s) 160, auditing system(s) 230, and privacy authority 240 can be enabled by a network 150, such as the Internet. Other implementations of the environment 200 can include additional systems or can distribute functionality differently among the systems.

The client device 160 interacts with the host computing system 110 to use one or more secure applications executed by the host system. Any of a variety of types of applications can use secure enclaves to ensure data privacy or when a tamper-proof environment is helpful to validate the authenticity of the application's output. For example, companies that sell commodities may send pricing information to an organization that publishes commodity indices. When a message with pricing information for a commodity is received by the organization, a secure enclave application operated by the organization stores the pricing information in an encrypted form and persistently in storage. The secure enclave application then retrieves the pricing information from storage, decrypts the pricing information, and calculates an index that is provided to a client device 160. To ensure the organization is executing the correct secure application (and thus to ensure that the calculated index is correct or that the applicable pricing data is secure), the client device 160 sends an audit request to the auditing systems 230.

The auditing systems 230 audit secure enclave applications to validate the instructions executed in an enclave. In some implementations, the auditing system 230 builds different versions of an enclave to be audited to create a set of binary files that represent the same enclave. For example, the auditing system 230 compiles a set of instructions to be executed in an enclave using different compilers or under different scenarios (e.g., under different system load conditions that cause threads to be completed in different orders in multi-thread environments). The auditing system 230 stores a hash value representing each binary (e.g., an MRENCLAVE value) in an enclave build repository 235. When a client 160 requests an audit of a host computing system's enclave, the auditing system 230 can compare a hash value of the build generated by the host computing system 110 to the set of hashes maintained in the enclave build repository 235. The auditing system 230 outputs an audit response to indicate whether the hash received from the host computing system matches one of the stored hash values.

In some implementations, a host computing system provides an auditing system 230 with information about the circumstances under which a particular secure enclave application was built (such as providing an identifier of the compiler used to build the enclave), enabling the auditing system 230 to recreate the build process and thereby validate the corresponding secure enclave.

In other implementations, the auditing system 230 disassembles a binary file received from the host computing system 110 to compare the disassembled instructions to the source code that is expected to be executed in an enclave. The auditing system 230 can automatically compare the disassembled instructions to expected source code to determine if the disassembled instructions match the expected source code. A match can be identified when the disassembled instructions have at least a threshold similarity to the expected source code or have at least a threshold similarity to specified portions of the expected source code, for example. Additionally or alternatively, the auditing system 230 includes a tool that matches disassembled instructions to source code for review by a human reviewer and outputs the matching for display to the reviewer. The tool can highlight disassembled instructions that do not have at least a threshold similarity to corresponding source code instructions to assist the reviewer in determining whether the disassembled instructions match the expected source code. The reviewer can then provide feedback to the auditing system 230 to indicate whether the disassembled instructions are a match.

If a disassembled binary file is found to match a set of source code expected to be executed in an enclave, the auditing system 230 stores an identifier of the binary file (e.g., an MRENCLAVE value) in the enclave build repository 235.

In some implementations, a comparison of disassembled instructions to expected source code is performed by a system other than the auditing system 230. For example, the client 160 can access the tool to disassemble code and generate a comparison between the disassembled code and the expected source code. A user of the client 160 can then analyze the outputs of the tool to determine whether to trust the code executed in the relevant secure enclave.

Each auditing system 230 can include a trusted execution environment 232 in which to build enclaves or perform comparisons between host computing system enclaves and the build versions produced by the auditing system 230. For example, when auditing an enclave of a host computing system, a secure enclave executed within the TEE 232 issues a query to a repository that stores built enclave identifiers. When the TEE 232 secure enclave receives a response to the query, it compares the enclave identifier in the received auditing request to the enclave identifier returned in response to the query. The TEE 232 can include similar functionality to the TEE 114 of the host computing system 110. Thus, the instructions executed by an auditing system 230 to build enclaves or produce audit results can themselves be audited by other auditing systems 230 in manners similar to that described herein for host computing system enclaves. Similarly, the TEE 232 can attest to its authenticity in manners similar to that described above for the host system's secure enclaves. For example, an enclave within the TEE 232 sends a client device a signer identifier to indicate an entity that signed the enclave. If the client device validates the signer identity, the client device requests an audit from the TEE 232 of the host system enclave.

The privacy authority 240 generates privacy policies for secure enclaves. In some implementations, the privacy authority 240 is incorporated into or administered by an entity associated with one or more of the auditing systems 230. The privacy authority 240 can generate privacy policies based on any combination of automated or manual analyses. For example, the privacy authority 240 can perform an automated evaluation of an enclave using a set of rules that test for various privacy-related aspects of the secure enclave code. A human reviewer can additionally or alternatively review the code. In some implementations, the host computing system 110 provides an expected privacy policy that represents intended features of the secure enclave code. In these cases, the privacy authority 240 can generate the privacy policy by evaluating actual features of the secure enclave code against the purported policy generated by the host system.

Each privacy policy is a user-readable description of a secure enclave's treatment of the data it processes, including how data will be used, stored, migrated, or shared. Some implementations additionally or alternatively include machine-readable descriptions of the treatment of data, for example to enable a privacy policy to be processed for automated evaluation by a client 160. Example aspects of a privacy policy, with corresponding policy attributes, include:

| Category | Aspect | Policy Attribute |
|---|---|---|
| User Inputs | In-memory Usage | No encryption |
| | | Encrypted by random/session key |
| | | Encrypted by key derived from |
| | | MRSIGNER |
| | | Clearance strategy: aggressive garbage |
| | | collection, programmatic clearance |
| | Storage | Not used |
| | | No encryption |
| | | Encrypted by random key, for swapping |
| | | purposes |
| | | Encrypted using key derived from |
| | | MRENCLAVE |
| | | Encrypted using key derived from |
| | | MRSIGNER |
| | | Encrypted using external key |
| | | Loading strategy: automatic or delayed |
| | | (e.g., wait until data owner approves |
| | | loading) |
| Enclave | Clearance Strategy | Aggressive garbage collection |
| Outputs | | Programmatic clearance |
| | Client session response | Type of response |
| | Storage | Not used |
| | | No encryption |
| | | Encrypted using random key, for |
| | | swapping purposes |
| | | Encrypted using key derived from |
| | | MRENCLAVE |
| | | Encrypted using key derived from |
| | | MRSIGNER |
| | | Encrypted using external key |
| | | Loading strategy: automatic or delayed |
| | | (e.g., wait until data owner approves |
| | | loading) |
| Relationship | | Outputs include user inputs (totally or |
| between | | partially) |
| Inputs and | | Outputs are derived irreversibly from |
| Outputs | | inputs (e.g., hash) |
| Access to | Clock | Access/no access |
| Host | Threading | Access/no access |
| Features | | |
| Security | Spectre/Meltdown | Partial, full, etc. |
| Features/ | CVE/Intel-SA mitigations | Present/absent |
| Hardening | Memory initialization | Present/absent |
| | Garbage collection | Present/absent |
| | Sandboxing | Present/absent |

Some secure enclaves operate in conjunction with other secure enclaves, for example with one secure enclave performing an operation on a value generated by a processing operation performed in a second secure enclave. For such linked secure enclaves, the privacy authority 240 can generate a chain of privacy policies that represent treatment of data across the set of linked enclaves. In an example, a first enclave uses a session key to encrypt data sent to the first enclave. A second enclave uses an MRSIGNER-derived key. Since the MRSIGNER-derived key is less secure than the session key, the privacy policy for the set of enclaves represented by the first enclave and the second enclave together indicates that data is encrypted using an MRSIGNER-derived key.

### Processing Sealed Client Data in Secure Enclaves

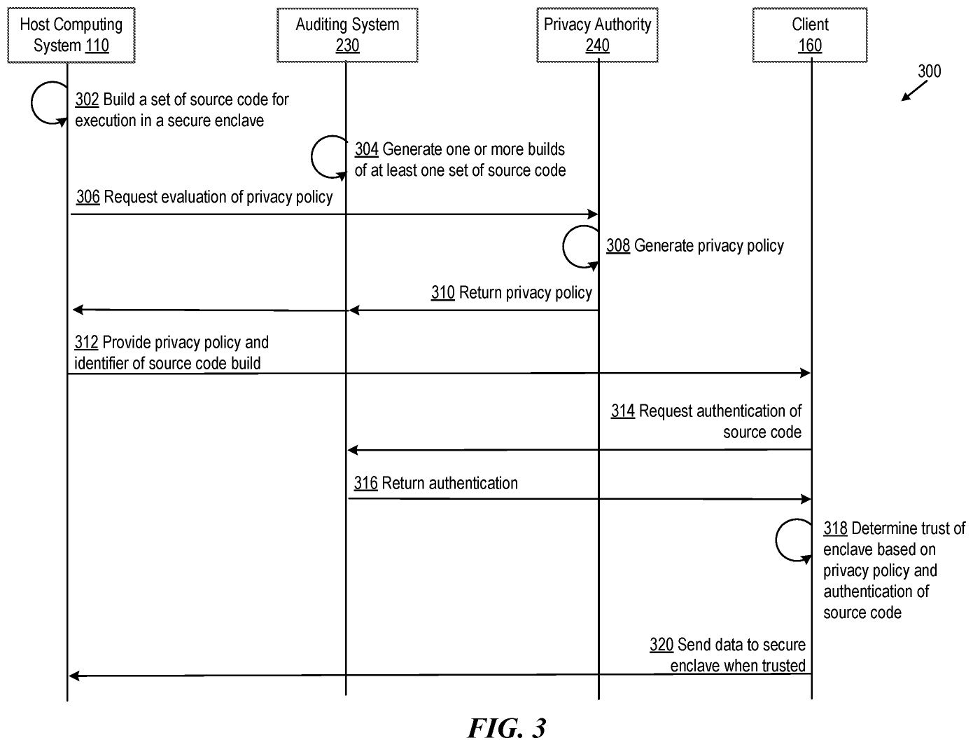

FIG. 3 is an interaction diagram illustrating a process 300 for initializing secure enclaves for processing data from clients 160, according to some implementations. As shown in FIG. 3, the process 300 can include interactions between the host computing system 110, one or more auditing systems 230, the privacy authority 240, and the client 160. Other implementations of the process 300 include additional, fewer, or different steps, or perform the steps in different orders. Furthermore, in other implementations, the steps can be performed by different entities than illustrated in FIG. 3. For example, while FIG. 3 illustrates a client 160 that sends data to a secure enclave application executing on the host computing system 110, other implementations of the process 300 do not include the client 160. Instead, another secure enclave or untrusted code on the host computing system 110 can request processing of data in a secure enclave, for example.

As shown in FIG. 3, the host computing system 110 builds a set of source code for execution in a secure enclave at step 302. For example, the host computing system 110 compiles the source code into object code, links libraries, packages an executable file, and/or causes a trusted execution environment to sign the executable file (e.g., using an MRSIGNER or MRENCLAVE) value. The output of the build process is an executable file associated with an enclave identifier (e.g., MRENCLAVE) and a signing identifier (e.g., MRSIGNER)

At step 304, the auditing system 230 generates one or more builds of at least one set of source code. The auditing system 230 can generate different builds of the same source code, for example using different compilers or under different circumstances to generate different executable files that each represent a build of the same source code. For each build, the auditing system 230 generates and stores an enclave identifier (e.g., by computing a hash value that represents a binary file produced by the build).

At step 306, the host computing system 110 requests evaluation of a privacy policy for the secure enclave from the privacy authority 240, which in turn generates the privacy policy at step 308 and returns the policy to the host computing system 110 at step 310. In some implementations, other entities can request and receive the privacy policy from the privacy authority 240, such as the auditing system 230 or the client 160.

At step 312, the host computing system 110 provides the privacy policy and an identifier of the source code build (e.g., an MRENCLAVE value) to the client 160. The privacy policy and the source code build identifier can be provided, for example, in response to a request from the client 160 prior to the client sending any data to the secure enclave, prior to the client sending an instruction to the secure enclave to unseal data that was transmitted to the secure enclave as sealed data, or both.

At step 314, the client 160 sends a request to the auditing system 230 to audit the secure enclave. The audit request includes the enclave identifier received from the host computing system 110. In some implementations, the client 160 first queries the auditing system 230 for information about a secure enclave at the auditing system 230 to attest to authenticity of the auditing system's enclave prior to sending data to the auditing system 230. For example, the client requests an MRENCLAVE and/or MRSIGNER from the auditing system. The client 160 validates the received value and transmits the request to audit a target secure enclave in response to successful validation.

The auditing system 230 validates the enclave identifier against known builds of the source code that is expected to be executed by the secure enclave. In some implementations, the auditing system 230 queries a data repository maintained by the auditing system, which includes enclave identifiers of enclaves built by the auditing system 230 or built by other trusted auditing systems. In some implementations, if the auditing system's own data repository does not include an enclave identifier that matches the enclave identifier received from the client, the auditing system 230 queries other auditing systems' data repositories. The auditing system 230 can also request attestation of the other auditing systems or audit the other auditing systems, in order to certify validity of any enclave builds by the other auditing systems.

At step 316, the auditing system 230 returns an authentication result to the client 160, indicating whether the target enclave was found to be valid or not found to be valid. Accompanying the validation result can be an authentication of the auditing system 230. For example, in implementations where the auditing system 230 stores an enclave build repository in secure enclave storage or performs at least part of the auditing process within a secure enclave, the auditing system 230 returns a validation result that includes an enclave identifier and/or a signer identifier associated with the auditing system's secure enclave. In another example, a first auditing system 230 requests auditing of its secure enclave by a second auditing system, and returns a validation result produced by the second auditing system.

The client 160 processes the privacy policy and the secure enclave authentication result to determine, at step 318, whether the secure enclave is trusted. For example, the client 160 evaluates whether the privacy policy indicates that the secure enclave will treat the client's data at least as securely as specified by a data handling policy associated with the data. If the privacy policy complies with the client's data handling policy and the authentication result indicates the secure enclave is executing the correct code, the client 160 can determine the enclave to be trusted. If the client does not trust either the privacy policy or the secure enclave authentication, the client 160 can instead determine the secure enclave to not be trusted.

When the client 160 establishes trust of the secure enclave, the client 160 can perform an action based on the trust. For example, as shown in FIG. 3, the client 160 sends data to the secure enclave, at step 320, for processing by the secure enclave. In another example, the client 160 sends the enclave an instruction to unseal data previously sent to a sealed data store associated with the secure enclave.

Some implementations of secure enclaves store client data in a sealed form until a time the data needs to be processed. Until the data is unsealed, an enclave cannot access or process the data. Sealing confidential data in this manner can be useful to prevent side channel attacks that may reveal some of an enclave's memory contents. However, once an enclave unseals data and begins processing the data, the data may still be leaked through side channel attacks. Even when an enclave is fully patched against all known attacks, a malicious host may exploit a new vulnerability to extract data by, for example, running an existing enclave or initiating a new enclave to unseal data from disk.

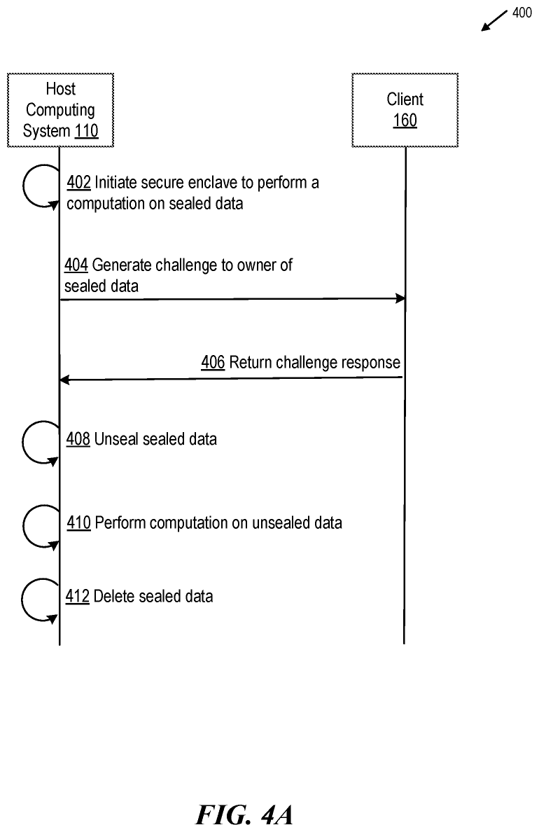

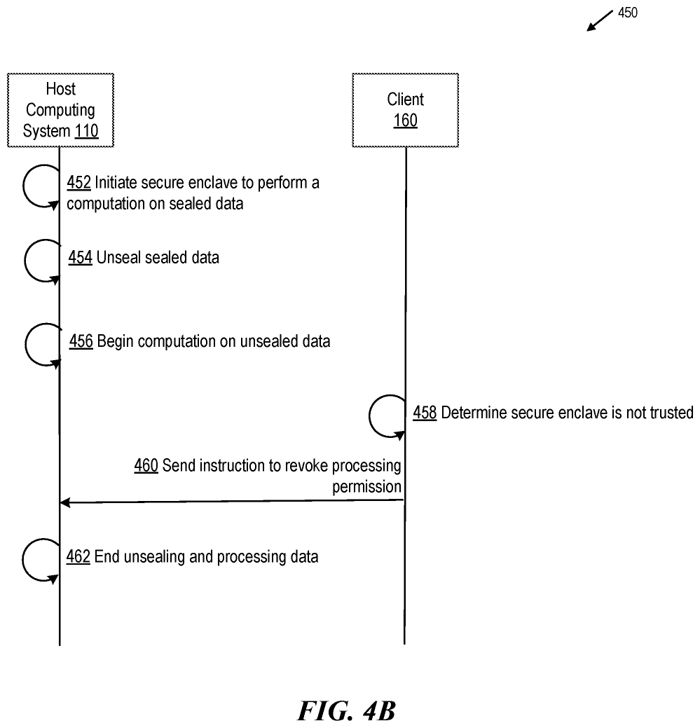

To reduce the likelihood that confidential client data will be leaked via a side channel attack, some implementations of a secure enclave give a data owner the right to control when and how the owner's data will be processed in the enclave. FIG. 4A is an interaction diagram illustrating a process 400 for processing client data in a secure enclave, according to some implementations. For example, the process 400 can be implemented in an environment in which a client evaluates a privacy policy and/or enclave authentication before granting a secure enclave's access to data. The process 400 can include interactions between the host computing system 110 (or a secure enclave executing on the host computing system 110) and an owner of data to be processed by the secure enclave, which is represented in FIG. 4A as being the client 160. Other implementations of the process 400 include additional, fewer, or different steps, or perform the steps in different orders.

At step 402, the host computing system 110 initiates a secure enclave to perform a computation on data that, at the time of enclave initiation, is stored in an encrypted format on a data storage device (“sealed to disk,” which may include sealing to the enclave or sealing to the author, or both). The data to be processed can be, for example, data received from the client 160 and sealed to disk by the secure enclave, data received from an external source and encrypted by the external source or the secure enclave, or data output based on processing performed by another secure enclave executed by the host computing system 110. The secure enclave must decrypt the sealed data (“unseal the data”) before the data can be processed within the secure enclave.

At step 404, the host computing system 110 generates a challenge to an owner of the sealed data. The challenge functions to notify the owner that the secure enclave is ready to begin processing of the owner's data and to give the owner the opportunity to approve or deny the secure enclave's permission to unseal and process the data. In general, the challenge requests an input from the data owner to confirm the data owner approves a secure enclave for processing the owner's data. Some challenges may request secret information, such as a password or cryptographic key, that serves to confirm an identity of the data owner and the data owner's approval to process sealed data. Some challenges may additionally request information that is necessary to unseal data, such as a cryptographic key or a portion of a key.

At step 406, the client 160 evaluates whether the secure enclave is trusted and, if the secure enclave is trusted, returns a challenge response to the host computing system 110. The challenge response is the analog to the challenge. For example, if the challenge requests a cryptographic key, the client 160 returns the requested key if the client determines the enclave is trusted. A client 160 may determine the secure enclave is trusted based on a policy applied at the client 160. For example, a client evaluates a privacy policy of the secure enclave to determine if the secure enclave will handle the sealed data in a manner consistent with the client's data handling policy, responding to the challenge only if the privacy policy is approved. In another example, the client 160 approves a secure enclave to process the client's data based on attestation by the secure enclave or based on auditing of the source code instructions executed by the secure enclave. If, for example, a validation result received from an auditor confirms the enclave is executing the correct build of source code instructions, the client 160 returns the challenge response. In still another example, the client 160 does not return a challenge response if the client has been notified of a potential vulnerability of the host computing system or the secure enclave, or if the client itself discovers a potential vulnerability.

The decision to return the challenge response can be an automated decision by the client 160 in some implementations. For example, the client 160 applies a policy to evaluate factors such as the secure enclave's privacy policy, audit results of the secure enclave, or whether any known vulnerabilities exist, enabling the client to assign a trust score to the secure enclave. If the trust score is greater than a specified threshold, the client determines the enclave is trusted and returns the challenge response to enable the enclave to process the client's data. In other implementations, the client 160 returns a challenge response based at least in part on a user input. For particularly sensitive types of data, for example, the client prompts a user of the client to confirm that processing of the data may proceed.

In response to the challenge response, the secure enclave at the host computing system 110 unseals the sealed data at step 408 and performs a computation on the unsealed data at step 410.

In some implementations, after processing the unsealed data (e.g., by performing a computation on the data), the host computing system 110 and/or the secure enclave within the host computing system deletes the sealed data at step 412. The host computing system 110 can also notify the client 160 that the data was deleted. Deleting the data can further improve privacy and security of the data. For example, deleting the data mitigates leakage of data in case that a malicious host attempts to cut communication with the data owner in order to keep the enclave's memory attack until a side channel attack is discovered. In some implementations, in addition to or instead of a secure enclave being configured to delete data after the data has been processed, some implementations of the host computing system 110 delete data for all secure enclaves executed by the host computing system if the system 110 detects a vulnerability that is likely to affect the secure enclaves and thus may compromise the data.

FIG. 4B is an interaction diagram illustrating another implementation of a process 450 for processing client data in a secure enclave, according to some implementations. Unlike the process 400, in which the secure enclave receives approval from a data owner prior to unsealing and processing data, the secure enclave according to the process 450 processes data until an instruction to stop is received from the data owner. Some steps of the process 450 can be similar to steps in the process 400 described with respect to FIG. 4A.

As shown in FIG. 4B, the host computing system 110 initiates a secure enclave, at step 452, to perform a computation on sealed data. The secure enclave unseals the sealed data at step 454 and begins performing the computation on the unsealed data at step 456.

During processing of the sealed data, the client 160 determines, at step 458, that the secure enclave is not trusted. For example, the client receives a notification of a potential vulnerability that may compromise security of the enclave.

When the client 160 determines that a secure enclave can no longer be trusted, the client sends an instruction to the secure enclave, at step 460, to revoke processing permission for the client's data.

In response to the instruction from the client, at step 462 the secure enclave ends any ongoing unsealing or processing of the client's data. The secure enclave can confirm to the client 160 that no further data processing will occur and/or delete any remaining sealed data from storage.

By enabling a secure enclave to process the data until revocation of processing permission is received from the data owner, the process 450 can process data more efficiently than the process 400, in which approval is requested from the data owner whenever data is to be processed. On the other hand, the process 400 may ensure greater security of the data. Accordingly, a secure enclave can be configured to operate according to the process 400 or the process 450, or a combination thereof, depending on the usage of the enclave. For example, a secure enclave can be configured to operate according to either process depending on factors such as sensitivity of the data to be processed, the amount of data that is to be processed, how frequently data needs to be unsealed from disk for processing in the enclave, or policies of the data owner. Some enclaves can additionally be configured to process data according to a process that has aspects from both the process 400 and the process 450. For example, some implementations of a secure enclave request permission from the data owner before unsealing data from disk (e.g., using challenge-response authentication), and enable the data owner to revoke permission at any time during processing of the data.

### Computer System

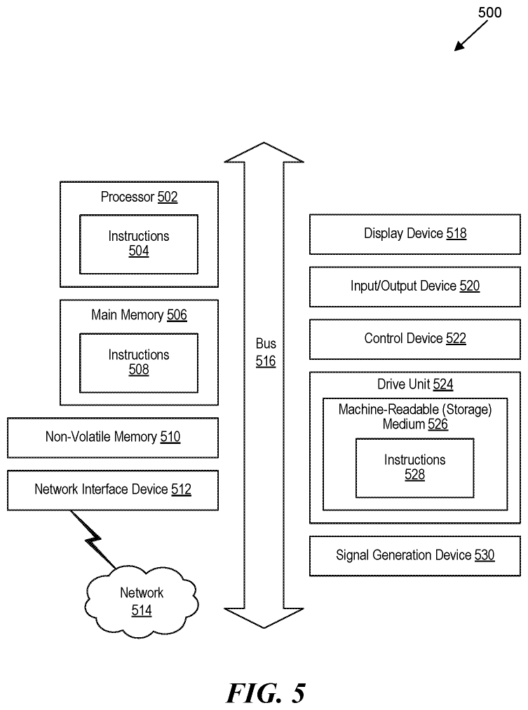

FIG. 5 is a block diagram that illustrates an example of a computer system 500 in which at least some operations described herein can be implemented. For example, the computer system 500 can implement the host computing system 110, a client device 160, and/or an auditing system 230. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer-readable storage medium, excluding transitory signals and carrying instructions, which, when executed by at least one data processor of a system, cause the system to:
send data to a secure enclave executing on a host computing system for processing within the secure enclave,
wherein the secure enclave is configured to seal the data and store the sealed data in a secure data repository;
receive a challenge query from the secure enclave;
process a privacy policy associated with the secure enclave to determine a trust level of the secure enclave; and
return a challenge response to the challenge query when the trust level of the secure enclave is greater than a specified threshold;
wherein the secure enclave is configured to unseal the sealed data in the secure data repository and perform a computation on the unsealed data in response to the challenge response.

2. The computer-readable storage medium of claim 1, wherein the instructions further cause the system to query a privacy authority for the privacy policy associated with the secure enclave.

3. The computer-readable storage medium of claim 1, wherein the instructions further cause the system to:
validate a set of source code instructions that are executable in the secure enclave; and
return challenge response in response to validating the set of source code instructions.

4. The computer-readable storage medium of claim 1, wherein the instructions further cause the system to:
receive a notification of a vulnerability of the host computing system or the secure enclave; and
determine the trust level of the secure enclave is below the specified threshold based on the notification.

5. A method performed by an application executing in a secure enclave on a central processing unit of a host computing system, the method comprising:
initiating, by the secure enclave, the application to perform a computation on sealed data stored outside the secure enclave;
wherein a fused key is fused into hardware of the central processing unit; and
wherein the sealed data is encrypted using an encryption key generated based on the fused key;
generating, by the secure enclave upon initiation of the application, a dynamic challenge to an owner of the sealed data; and
in response to a challenge response received from the owner of the sealed data:
unsealing the sealed data using a decryption key generated based on the fused key; and
executing the application, in the secure enclave, to perform the computation on the unsealed data.

6. The method of claim 5, wherein the sealed data is stored in a data repository accessible to the secure enclave, and wherein the method further comprises:
after causing the secure enclave to perform the computation on the unsealed data, deleting the sealed data from the data repository.

7. The method of claim 6, further comprising:
sending a confirmation to the owner of the sealed data to indicate the sealed data has been deleted from the data repository.

8. The method of claim 5, further comprising:
transmitting a privacy policy to a client device associated with the owner of the sealed data, wherein the privacy policy includes a user-readable description of one or more aspects of data treatment by the secure enclave;
wherein the client device is configured to:
process the privacy policy based on a data handling policy associated with the owner of the sealed data; and
output the challenge response to the host computing system when the privacy policy complies with the data handling policy.

9. The method of claim 8, further comprising:
sending a representation of source code instructions executed by the secure enclave to a privacy authority,
wherein the privacy authority is configured to generate the privacy policy based on an analysis of the representation of source code instructions.

10. The method of claim 8, wherein the secure enclave is a first secure enclave configured to receive data from a second secure enclave or to output data to a third secure enclave, and wherein the privacy policy represents data treatment by both the first secure enclave and the second secure enclave or both the first secure enclave and the third secure enclave.

11. The method of claim 5, further comprising;
receiving an instruction from the owner of the sealed data to end processing of the unsealed data; and
in response to the instruction, ending performance of the computation on the unsealed data.

12. A host computing system comprising:
at least one hardware processor,
wherein a fused key is fused into the at least one hardware processor; and
at least one non-transitory memory storing instructions, which, when executed by the at least one hardware processor, cause the host computing system to:
access, from a secure data repository, sealed data associated with an owner;
initiate one or more secure enclaves to perform a computation on the sealed data;
generate a dynamic challenge to the owner of the sealed data; and
in response to a challenge response received from the owner of the sealed data:
unsealing the sealed data using a decryption key generated based on the fused key; and
causing the one or more secure enclaves to perform the computation on the unsealed data.

13. The host computing system of claim 12, wherein the instructions further cause the host computing system to:
detect a vulnerability that is likely to affect the one or more secure enclaves; and
in response to detecting the vulnerability, deleting the sealed data from the secure data repository.

14. The host computing system of claim 12, wherein generating the dynamic challenge to the owner of the sealed data comprises sending the dynamic challenge to a client application the host computing system.

15. The host computing system of claim 12, wherein generating the dynamic challenge to the owner of the sealed data comprises sending the dynamic challenge to a client device remote from the host computing system.

16. The host computing system of claim 12, wherein the instructions further cause the host computing system to:
after causing the one or more secure enclaves to perform the computation on the unsealed data, delete the sealed data from the secure data repository; and
send a confirmation to the owner of the sealed data to indicate the sealed data has been deleted from the data repository.

17. The host computing system of claim 12, wherein the instructions further cause the host computing system to:
transmit a privacy policy to a client device associated with the owner of the sealed data, wherein the privacy policy includes a user-readable description of one or more aspects of data treatment by the one or more secure enclaves;
wherein the client device is configured to:
process the privacy policy based on a data handling policy associated with the owner of the sealed data; and
output the challenge response to the host computing system when the privacy policy complies with the data handling policy.

18. The host computing system of claim 17, wherein the instructions further cause the host computing system to:
send a representation of source code instructions executed by the one or more secure enclaves to a privacy authority,
wherein the privacy authority is configured to generate the privacy policy based on an analysis of the representation of source code instructions.

19. The host computing system of claim 17, wherein the one or more secure enclaves include a first secure enclave configured to receive data from a second secure enclave or to output data to a third secure enclave, and wherein the privacy policy represents data treatment by both the first secure enclave and the second secure enclave or both the first secure enclave and the third secure enclave.

20. The host computing system of claim 12, wherein the instructions further cause the host computing system to;
receive an instruction from the owner of the sealed data to end processing of the unsealed data; and
in response to the instruction, end performance of the computation on the unsealed data.
